(19) United States
(12) Patent Application Publication
(10) Pub. No.: US 2020/0311747 A1
(43) Pub. Date: Oct. 1, 2020

(54) IDENTIFYING THE PRIMARY OBJECTIVE IN ONLINE PARAMETER SELECTION

(71) Applicant: Microsoft Technology Licensing, LLC, Redmond, WA (US)

(72) Inventors: Yunbo Ouyang, Sunnyvale, CA (US); Kinjal Basu, Sunnyvale, CA (US); Viral Gupta, Sunnyvale, CA (US); Shaunak Chatterjee, Sunnyavle, CA (US)

(21) Appl. No.: 16/370,127

(22) Filed: Mar. 29, 2019

(51) Int. Cl. G06Q 30/02; G06N 5/04; G06Q 10/06; G06N 7/00; H04L 29/08

(52) U.S. Cl. CPC G06Q 30/0201; G06N 5/04; H04L 67/22; G06N 7/005; G06Q 10/063

(57) ABSTRACT

Techniques for automatically identifying a primary objective for a multi-objective optimization problem are provided. In one technique, an experiment is conduct and results of the experiment involving different values of a model parameter are tracked and stored. Multiple metrics are generated based on the results. For each metric, a maximum or minimum value of the metric given a particular value of the model parameter is determined and a variance associated with the metric is determined based on the maximum or minimum value. A metric that is associated with the lowest variance among the multiple metrics is identified. The identified metric is used as a primary metric in a multi-objective optimization problem.

### TECHNICAL FIELD

The present disclosure relates to online experiments and, more particularly, to automatically selecting a primary metric for a multi-objective optimization problem.

### BACKGROUND

Providers of online products attempt to optimize multiple metrics of interest. While doing so, such providers typically pick one metric as the primary metric while keeping thresholds on other metrics. For example, in determining whether to send a notification (about an online or real world occurrence) to one or more registered users, one might maximize for number of views (the primary metric), while keeping the number of “disables” (a secondary metric) below a particular threshold, where a “disable” is a registered user selecting an option to disable future notifications, which selection effectively removes that registered user as a candidate recipient of future notifications. The same problem can be formulated as minimizing the disable rate (the primary metric) while keeping the number of views (a secondary metric) above a particular threshold.

However, it is not trivial to pick which metric should be kept as the main (or primary) objective. In one approach, product engineers select the primary metric via previous experience, not through a quantitative method. Selecting the wrong metric as the primary metric may result in poor (not just sub-optimal) performance of the corresponding product, which performance would be reflected in at least one metric exhibiting significantly worse performance than if a better metric was selected as the primary metric.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for selecting a metric as a primary objective, in an embodiment;

FIG. 2 is a flow diagram that depicts an example process for selecting a metric from among multiple metrics as a primary metric, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for selecting a primary metric of multiple candidate metrics in a multi-objective domain. In one technique, multiple metrics or utilities are identified, along with a range of values for a model parameter. An (e.g., online) experiment is run with different values within the range. Results of the experiment are gathered and metric values are calculated for each tested parameter value. For each metric, the variance of the maximum of that metric/utility is estimated. The metric that is associated with the lowest variance is selected as the primary metric. The other metrics become secondary objectives in the multi-objective problem.

Embodiments represent an improvement to computer-related technology in that an optimal metric is selected as a primary metric, enabling improved performance of a computerized system along the selected metric and other metrics. Embodiments involve automatic identification of the primary metric as well as the automatic identification of one or more values of a model parameter used in a computerized system. In this way, manual selection of a sub-optimal metric as the primary objective is avoided.

### System Overview

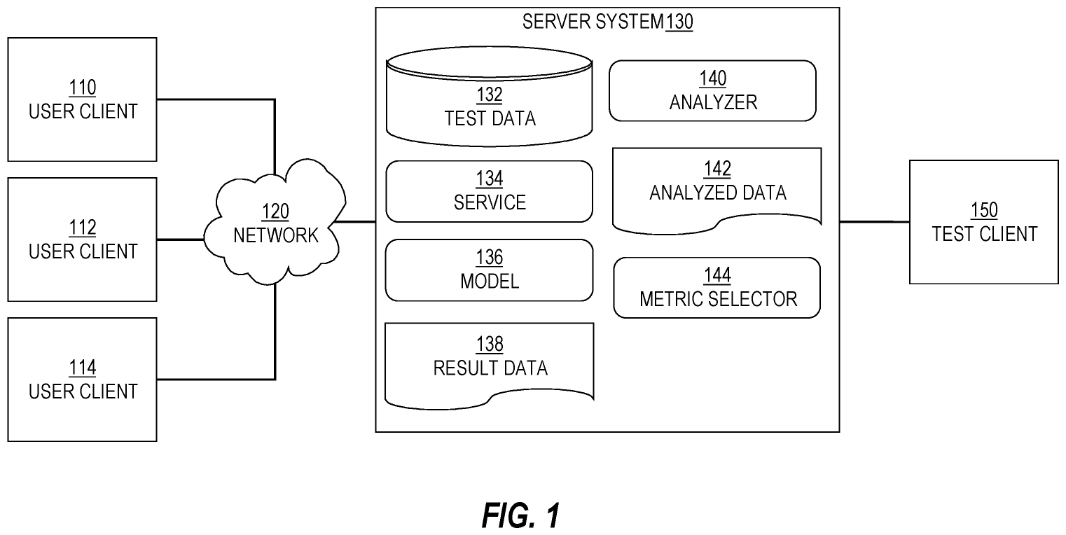

FIG. 1 is a block diagram that depicts an example system 100 for selecting a metric as a primary objective, in an embodiment. System 100 includes user clients 110-114, network 120, server system 130, and test client 150.

Each of user clients 110-114 and test client 150 is an application or computing device that is configured to communicate with server system 130 over network 120. Examples of computing devices include a laptop computer, a tablet computer, a smartphone, a desktop computer, and a personal digital assistant (PDA). An example of an application includes a native application that is installed and executed on a local computing device and that is configured to communicate with server system 130 over network 120. Another example of an application is a web application that is downloaded from server system 130 and that executes within a web browser running on a computing device. Each of user clients 110-114 may be implemented in hardware, software, or a combination of hardware and software. Although only three user clients 110-114 are depicted, system 100 may include many more clients that interact with server system 130 over network 120.

Network 120 may be implemented on any medium or mechanism that provides for the exchange of data between user clients 110-114 and server system 130 and between test client 150 and server system 130. Examples of network 120 include, without limitation, a network such as a Local Area Network (LAN), Wide Area Network (WAN), Ethernet or the Internet, or one or more terrestrial, satellite or wireless links.

### Server System

Server system 130 includes test data 132, service 134, model 136, result data 138, analyzer 140, analyzed data 142, and metric selector 144. Although depicted as a single element, server system 130 may comprise multiple computing elements and devices, connected in a local network or distributed regionally or globally across many networks, such as the Internet. Thus, server system 130 may comprise multiple computing elements other than the depicted elements.

Test data 132 defines one or more parameters to be used in an experiment and is determined based on input from test client 150. Examples of test data 132 include a value range of each of one or more model parameters. For example, a model parameter may be of a prediction model (e.g., model 136) that predicts a likelihood that a user performs some action, such as selecting a candidate content item if the content item is presented to the user or viewing a candidate video. The model parameter may be an input of the prediction model. For example, in determining which content items to include in an online (e.g., news) feed, the model parameter is a model combination parameter, which combines the score from the click model and the score from the viral model. As another example, in determining whether to send a notification, the model parameter is a tune threshold, such that a notification is only sent if the score (output of the prediction model) is larger than the tune threshold.

The value range of a model parameter may be automatically determined based on no input or some input. Alternatively, a user operating test client 150 specifies the range of values to test.

Test data 132 may also specify a time in which the experiment will run, a number of users, and/or a percentage of users that request (or rely indirectly on) a particular service (e.g., service 134) provided by server system 130. For example, a user, operating test client 150, might specify 1% as the percentage of users who visit or rely on the particular service that will be subject to an experiment involving different values of a model parameter.

Service 134 is hosted by server system 130. Examples of service 134 includes a notification service, a people you may know (PYMK) service, and a feed service. A notification service is one that sends a notification (e.g., daily, hourly, or in response to a certain) to individual users (e.g., of user clients 110-114). The notification service determines whether a notification should be sent, depending on various factors or features, such as the identity of the intended recipient, attributes of the intended recipient (e.g., job title, current employer, skills, geographic location, number of online connections, etc.), identity of a user that is a subject referenced in content of the notification, identity of the author of the content of the notification, a time of day, a day of the week, a type of device that the intended recipient is currently using, whether the author and the intended recipient are connected in an online social network, etc. The notification service relies on model 136 (by inputting values of different features into model 136) to determine whether to send a particular notification to a particular recipient. Model 136 outputs a value that the notification service uses to determine whether to send the particular notification. The notification service compares the value to a particular threshold, above or below which the notification service will send the particular notification.

A PYMK service is one that determines whether (or which) users will be presented to a particular user. The candidate users are not current connected to the particular user in an online social network. A purpose of the PYMK service might be to help each user to become connected to as many other users (whose connections might provide value to the user) as possible. The PYMK service is similar to the notification service in that the PYMK service identifies attributes of a target user and attributes of a candidate user and inputs those attributes into a model (e.g., model 136), which outputs a value that the PYMK service uses to determine (a) which candidate user to present to the target user and/or (b) how to rank a set of candidate users. The PYMK service may compare the output value to a threshold, above which the PYMK service presents information about the candidate user to the target user, and below which the PYMK service will not present to the target user, or only if the target user scrolls through information about the presented candidate users far enough.

A feed service is one that determines which content items to present to a target user in an online feed presented to the target user. A purpose of the feed service might be present as relevant of content items as possible to the target user so that the target user obtains value from the feed service and is, therefore, more likely to return to server system 130. The feed service is similar to the notification service in that the feed service identifies attributes of the target user, attributes of a candidate content item, attributes of an author of the candidate content item, and/or attributes of a subject that the candidate content item references and inputs those attributes into a model (e.g., model 136), which outputs a value that the feed service uses to determine (a) which candidate content item to present to the target user and/or (b) how to rank a set of candidate content items. The feed service may compare the output value to a threshold, above which the feed service presents information about the candidate content item to the target user, and below which the feed service will not present to the target user, or only if the target user scrolls through the online feed far enough.

Result data 138 is log data generated as a result of user interactions with service 134. For example, if a user selects a notification, then server system 130 generates a selection record that indicates one or more of the following: the action of selecting a notification, an identity or user identifier of the user, a notification identifier uniquely identifying the notification, a content identifier uniquely identifying a content item that is subject of (or referenced by) the notification, a day of the week on which the selection occurred (e.g., Saturday), a time of day of the selection (e.g., 13:11), an experiment identifier that uniquely identifies an experiment that caused the notification to be sent (if the notification was sent to the user as a result of an experiment), and a model parameter value (e.g., 0.46) that was generated before determining to send the notification to the user. Result data 138 may also include log data regarding downstream actions performed by users, such as selecting a link in content of a notification. In this way, not only can selections of notifications be logged, but also downstream actions of those selections.

As another example, if a user selects a disable notification option, then server system 130 generates a disable record that indicates one or more of the following: the action of disabling future notifications, an identity or user identifier of the user, whether the user is part of an experiment (which may be determined separately based on the user identifier), a day of the week on which the disable selection occurred, and a time of day of the disable selection.

Analyzer 140 is component of server system 130. Analyzer 140 is implemented in software, hardware, or any combination of software and hardware. Analyzer 140 analyzes result data 138 and generates metric data 142 therefrom. Metric data 142 comprises data about multiple metrics, each corresponding to a different utility. For example, analyzer 140 determines, based on result data 138, for each test group of an experiment (each test group corresponding to a different set of one or more model parameter values), a number of notifications sent (or “sends”) as a result of the model parameter value being in the corresponding set, a number of selections of such notifications, a selection rate of such selections (number of such selections/number of such sends), a number of disables that users selected within a certain time frame (e.g., a minute) of receiving such a notification, and/or a disable rate of such disables (number of disables/number of such sends).

Metric selector 144 is a component of server system 130. Metric selector 144 is implemented in software, hardware, or any combination of software and hardware. Metric selector 144 analyzes metric data 142 and outputs a metric that should be used as a primary objective in a multi-objective optimization problem. An example of a multi-objective optimization problem is maximizing some metric (e.g., user selection rate or click-through rate (CTR)) while keeping another metric (e.g., disables) below a particular threshold. A more specific example of a multi-objective optimization problem is maximizing the number of viral actions (e.g., shares) on a feed while keeping engaged feed sessions above a first threshold and revenue above a second threshold.

### Account Database

Although not depicted, server system 130 may comprise an account database that comprises information about multiples accounts. The account database may be stored on one or more storage devices (persistent and/or volatile) that may reside within the same local network as server system 130 and/or in a network that is remote relative to server system 130. Thus, although depicted as being included in server system 130, each storage device may be either (a) part of server system 130 or (b) accessed by server system 130 over a local network, a wide area network, or the Internet.

In a social networking context, server system 130 is provided by a social network provider, such as LinkedIn, Facebook, or Google+. In this context, each account in the account database includes a user profile, each provided by a different user. A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network (but that are registered users/members of the social network provider).

Some data within a user's profile (e.g., work history) may be provided by the user while other data within the user's profile (e.g., skills and endorsement) may be provided by a third party, such as a “friend,” connection, colleague of the user.

Server system 130 may prompt users to provide profile information in one of a number of ways. For example, server system 130 may have provided a web page with a text field for one or more of the above-referenced types of information. In response to receiving profile information from a user's device, server system 130 stores the information in an account that is associated with the user and that is associated with credential data that is used to authenticate the user to server system 130 when the user attempts to log into server system 130 at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, server system 130 stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in a user profile is determined automatically by server system 130 (or another automatic process). For example, a user specifies, in his/her profile, a name of the user's employer. Server system 130 determines, based on the name, where the employer and/or user is located. If the employer has multiple offices, then a location of the user may be inferred based on an IP address associated with the user when the user registered with a social network service (e.g., provided by server system 130) and/or when the user last logged onto the social network service.

While some examples herein are in the context of online networks, embodiments are not so limited.

### Problem Setup

Embodiments are not limited to any particular multi-objective optimization problem. When describing embodiments, examples are based on a two-objective optimization problem; however, other optimization problems may include more than two objectives.

Generically, the metrics of interest are defined as U₁(x), U₂(x), . . . , U [symbol] (x), where x is the parameter over which to optimize. An example of x is a model output that indicates a probability or likelihood that a user will select a candidate content item. Examples of x include:
a. for Notifications: CTR, Disables, etc., where x is the send threshold;
b. for PYMK: Acceptance Rate, Connection Rate, Impression Rate, etc., where x is the parameter for combining the different models to get the score.
c. for Feed: Viral actions, Engaged Feed Sessions, Revenue clicks, etc., where x is the parameter for combining the different models to get the score.

The optimization problem can then be written as:

$$Maximize U \text{?} ( x ) such that U \text{?} ( x ) \geq {c}_{i} for all i = 2 , … , n$$

$$\text{?} \text{indicates text missing or illegible when filed}$$

where cᵢ is a threshold for utility (or metric) i.

In this example, the primary objective selected is U₁; however, the primary objective could be something else, such as U₂, or U₃. The above optimization problem is converted to maximizing a single optimization function U(x) by introducing Lagrangian:

$$U ( x ) = {U}_{1} ( x ) + λ \sum \text{?} σ ( U \text{?} ( x ) - {c}_{i} ) \text{?}$$

$$\text{?} \text{indicates text missing or illegible when filed}$$

where λ is a large number and σ(·) is a sigmoid function. The fluctuation of U(x) primarily comes from U₁(x). Therefore, choosing the primary objective which has low fluctuation will make the problem easy to converge.

A multi-objective optimization problem in the above form is easiest to solve when the variance of the primary objective is the lowest. A smooth objective is much easier to optimize than something that is extremely “spiky” or whose variance is relatively high. Therefore, in embodiments described herein, the primary objective is automatically identified by estimating the variance of each metric of multiple metrics. The following section describes how variance can be calculated for a metric using different values for a model parameter.

### Variance Calculation

For example, to model user selections (e.g., clicks) of notifications, the following formula may be used:

$${Y}_{i}^{1} ( x ) \text{∼} B in ( {n}_{i} ( x ) , σ ( {f}^{1} ( x ) ) )$$

where nᵢ(x) denotes the total number of sends to member i by using x, Yᵢ¹(x) denotes the total number of user selections (e.g., clicks) by member i by using x, f¹(x) is a real valued function after an inverse logit transformation of metric 1, and σ(f¹(x)) represents the underlying metric/utility to be estimated. The range of σ(f¹(x)) is [0, 1]. It is assumed that f¹(x) follows a Gaussian process. Moreover, aggregated data at x may be observed, i.e., the following may be observed from results gathered from an experiment involving different values of x:

$${Y}^{1} ( x ) \text{∼} B in ( n ( x ) , σ ( {f}^{1} ( x ) ) )$$

where n(x) is the total number of sends when the model parameter's value is x. Y¹(x) is the total number of user selections. Understanding how Y¹ fluctuates as a function of x can be captured as follows:

$$Var ( Y ( x ) ) - E ( V ( Y ( x ) \vert f ( x ) ) ) + V ( E ( Y ( x ) \vert f ( x ) ) ) = E ( n ( x ) σ ( f ( x ) ) ( 1 - σ ( f ( x ) ) ) ) + V ( n ( x ) σ ( f ( x ) ) )$$

$$Var ( Y ( x ) ) = n ( x ) [ E ( σ ( f ( x ) ) ) - {\{ E ( σ ( f ( x ) ) ) \}}^{2} - V ( σ ( f ( x ) ) ) ] + {n ( x )}^{2} V ( σ ( f ( x ) ) ) = n ( x ) E ( σ ( f ( x ) ) ) ( 1 - E ( σ ( f ( x ) ) ) ) + V ( σ ( f ( x ) ) ) ( {n ( x )}^{2} - n ( x ) )$$

Using simplifications in the paper entitled, “Semi-analytical approximations to statistical moments of sigmoid and softmax mappings of normal variables”, by J. Daunizeau (incorporated herein by reference), the expectation and variance terms may be simplified as follows:

$$E ( σ ( f ( x ) ) ) = σ ( \frac{μ ( x )}{\sqrt{1 + ak ( x , x )}} ) where a = 0.368 . \\ and$$

$$V ( σ ( f ( x ) ) ) = σ ( \frac{μ ( x )}{\sqrt{1 + ( 3 \text{/} {π}^{2} ) k ( x , x )}} ) ( 1 - σ ( \frac{μ ( x )}{\sqrt{1 + ( 3 \text{/} {π}^{2} ) k ( x , x )}} ) ) ( 1 - \frac{1}{\sqrt{1 + ( 3 \text{/} {π}^{2} ) k ( x , x )}} )$$

After fitting the Gaussian process on f¹(x), [symbol] (x) and k(x,x) can be estimated, where [symbol] (x) is the posterior mean function and k(x,x) is the posterior variance function. These functions can be estimated simultaneously for every point x. Thus, the variance of Y(x) or (Var(Y(x)) can be estimated at every point x. For similar metrics or utilities, the formulation can be derived depending on the modeling assumption. In the above example, the modeling assumption is a binomial distribution. The number of objectives or metrics does not affect the modeling assumption. Other modeling assumptions include a Poisson distribution and a Gaussian distribution. The above equation to compute Var(Y(x)) only applies to a Binomial distribution. For a Gaussian distribution, the following is assumed:

$${Y}^{1} ( x ) \text{/} {n}^{1} ( x ) \text{∼} N ( {f}^{1} ( x ) , {σ}^{2} \text{/} {n}^{1} ( x ) )$$

$$Var ( Y ( x ) ) = k ( x , x ) + {σ}^{2} \text{/} {n}^{1} ( x ) and Var ( {f}^{1} ( x ) ) = k ( x , x ) ,$$

where σ² is the estimated noise.
For a Poisson distribution, the following is assumed:

$${Y}^{1} ( x ) \text{∼} Poisson ( {n}^{1} ( x ) * exp ( {f}^{1} ( x ) ) )$$

$$Var ( exp ( {f}^{1} ( x ) ) ) = exp ( 2 \text{?} ( x ) + k ( x , x ) ) * ( exp ) ( k ( x , x ) ) - 1$$

$$\text{?} \text{indicates text missing or illegible when filed}$$

### Distribution Fitting

Distribution fitting is the procedure of selecting a statistical distribution that best fits to a data set generated by a random process. In other words, given certain data, it is good to know which distribution can be used to describe the data. Random factors affect all areas of our life, and businesses striving to succeed in today's competitive environment need a tool to deal with risk and uncertainty involved. Using probability distributions is a scientific way of dealing with uncertainty and making informed business decisions.

In practice, probability distributions are applied in such diverse fields as actuarial science and insurance, risk analysis, investment, market research, business and economic research, customer support, mining, reliability engineering, chemical engineering, hydrology, image processing, physics, medicine, sociology, and demography.

Probability distributions can be viewed as a tool for dealing with uncertainty: distributions are used to perform specific calculations and the results are applied to make well-grounded business decisions. However, if the wrong tool is used, then the wrong results will be obtained. If an inappropriate distribution (the one that doesn't fit to the data well) is selected and applied, then subsequent calculations will be incorrect, which will certainly result in poor decisions.

In many industries, the use of incorrect modeling assumptions can have serious consequences, such as inability to complete tasks or projects in time leading to substantial time and money loss or incorrect engineering design resulting in poor online user experience or damage of expensive equipment.

Distribution fitting allows valid models of random processes to be developed, protecting from potential time and money loss, which can arise due to invalid model selection, and enabling better business decisions.

### Fluctuating Metrics

Although the variance of a metric may be estimated at each point in the domain, such an estimate does not provide a clear understanding of the metric, i.e., whether the variance of the metric is very spiky. Towards understanding that, a different approach is followed.

Once a Gaussian Process (GP) is fit on the data at every iteration (where “iteration” may vary depending on the frequency of the experiment(s), such as a single day, a six hour period, or a four hour period), samples from the GP may be drawn and the maximum of the metric may be estimated. For example, ten thousand functions are drawn from the posterior GP, resulting in:

$$x \text{?} - argmax f \text{?} ( x ) for \text{?} - 1 \text{?} 10000$$

$$\text{?} \text{indicates text missing or illegible when filed}$$

The arg max is taken from, in this example, ten thousand functions of x. The function f¹(x) is an unknown function and is being estimated. The posterior distribution of f¹(x) captures all the information that is learned from the data. To allocate traffic for each parameter, we seek the distribution of optimal parameters. Samples from the posterior distribution are taken and the optimal point is found for each sample. The optimal points are aggregated as the optimal point distribution. There may be a large number of grids to search for the optimal point. Evaluating the sample function values may have very small computational cost. Once we have these x [symbol] ᵢ,a histogram of x [symbol] ᵢ may be drawn. The sharper the peak of the histogram, the easier it is to estimate the maximum. If the maximum occurs at several values of x, then it is difficult to obtain an accurate maximum. This information can be used to identify the metric which should act as a primary metric, weighted by the metric's variance.

Let xᵢ be the maximum with probability p [symbol] =No. of times xᵢ occurred as max/10000. Then, an estimate of the variance of the maximum is as follows:

$$T = Var ( Max ( Y ( x ) ) ) \approx \text{?} {p}_{i} V ( Y ( {x}_{i} ) )$$

$$\text{?} \text{indicates text missing or illegible when filed}$$

This formula for T sums, for each maximum, the product of (i) the probability of that maximum and (2) the variance of the output metric given that maximum.

For example, after sampling ten thousand functions, it is determined that (1) x₁ is determined to be the maximum in eight thousand of the ten thousand functions and (2) x₂ is determined to be the maximum in two thousand of the ten thousand functions. Thus, this implies that the variation of the maximum of the sigmoid of f(x) is 0.8 times the variation at x₁ plus 0.2 times the variation at x₂. This gives the overall variance based on the probability of how this metric behaves at the maxima.

Metric T is not associated with any parameter x. Instead, the value of T is a measure of the fluctuation (or variance) of the metric. Different metrics or utilities will likely have different T values. The different metrics or utilities are compared based on their respective T values. The metric or utility with the lowest T may be selected. One or more factors other than the T value may be used to select a utility, particularly if multiple utilities have the same Tor T values that are very similar to each other.

### Over-Dispersion And Under-Dispersion

The above technique depends on a modeling assumption and, in many cases, the model that is fitted can underestimate or overestimate for the “dispersion,” which is the extent to which a distribution is stretched or squeezed. Example measures of dispersion include standard deviation, mean absolute difference, and median absolute deviation. Dispersion is not easily estimated unless there is access to the non-aggregated data.

For example, at any x, it may be observed that:

$$Y ( x ) = {\sum }_{i} {Y}_{i} ( x ) and n ( x ) = {\sum }_{i} {n}_{i} ( x )$$

Presuming that p(x)=Y(x)/n(x) is the utility, in order to estimate Var(p(x)), individual components are needed. If over-dispersion or under-dispersion is suspected, then this estimate can be compared to the following variance estimate Var(p(x))≈p(x)(1−p(x)) if a Binomial distribution is assumed. Depending on the situation, modeling changes are incorporated to address such concerns.

### Jackknife Sampling

In many scenarios, un-aggregated data is available, such as (Yᵢ(x), nᵢ(x)) for a given parameter x and a given member i. However, what is ultimately modeled is based on aggregated data, such as:

$$Y ( x ) = {\sum }_{i} {Y}_{i} ( x ) and n ( x ) = {\sum }_{i} {n}_{i} ( x )$$

Y(x) is presumed to follow a Binomial distribution with parameters n(x) and σ(f(x)). Let p(x)=Y(x)/n(x), which implies the assumption that

$$Var ( p ( x ) ) \approx p ( x ) ( 1 - p ( x ) ) .$$

In order to test whether this assumption is true, if Var(p(x)) is much larger than p(x)(1−p(x)), then the distribution of the underlying data exhibits over-dispersion; however, if Var(p(x)) is much smaller than p(x)(1−p(x)), then the distribution of the underlying data exhibits under-dispersion.

Because there is access to unaggregated data, Var(p(x)) can be efficiently computed using a Jackknife resampling technique as follows. Given a total of i members, for each member i, a ratio is computed without member i:

$${p}_{- i} ( x ) = \frac{Y ( x ) - {Y}_{i} ( x )}{n ( x ) - {n}_{i} ( x )} .$$

Then the estimate of the variance Var(p(x)) is computed as follows:

$$V ( x ) = \frac{I - 1}{I} {\sum }_{i} {( {p}_{- i} ( x ) - \overline{p} ( x ) )}^{2} ,$$

where

$$\overline{p} ( x ) = \frac{1}{I} {\sum }_{i} \qquad {p}_{i} ( x ) .$$

If V(x) (which is an estimate of Var(p(x))) is very different from p(x)(1−p(x)) (e.g., by one or more orders of magnitude), then a different modeling approach may be used. For example, if a binomial distribution is initially assumed and Jackknife shows the assumption is wrong, then a Poisson distribution or a Gaussian distribution may be assumed.

### Process Overview

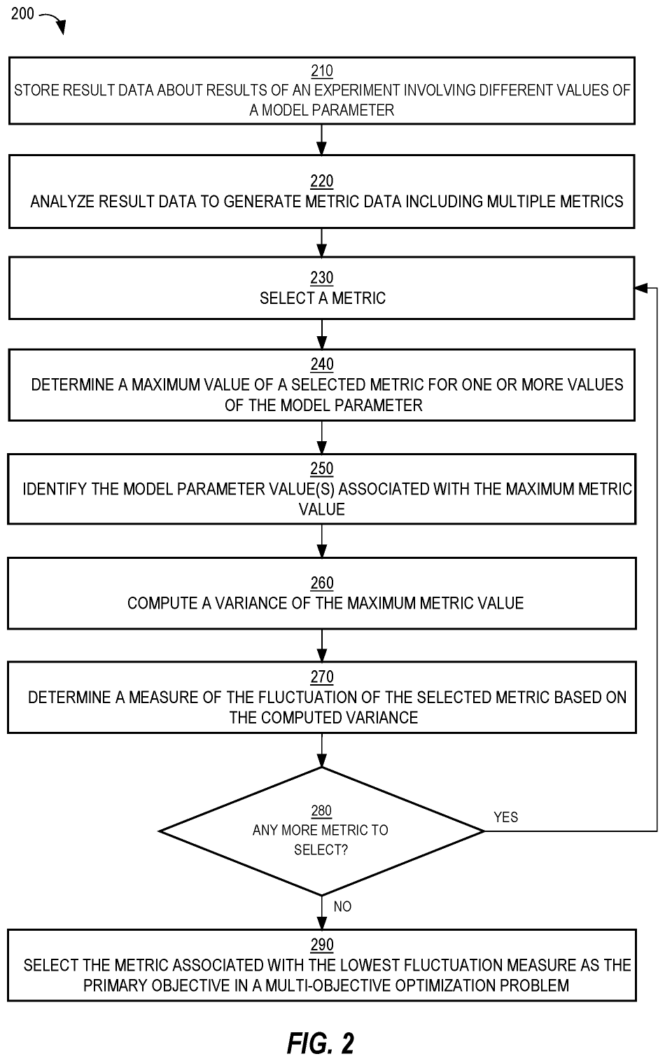

FIG. 2 is a flow diagram that depicts an example process 200 for selecting a metric from among multiple metrics as a primary metric for a primary objective of a multi-objective optimization problem, in an embodiment.

At block 210, result data about results of an experiment involving different values of a model parameter is stored. The result data may be generated in response to user interactions with content provided by server system 130. The experiment involves testing the different values of the model parameter. For example, if the model parameter is a likelihood of user interaction (e.g., a click or a view) given a candidate content item, then the possible range of values may be between 0 (indicating zero likelihood of user interaction) and 1 (indicating certainty of user interaction). However, the range of values of x that are tested may be smaller than the possible range, such as 0.3 to 0.8. Parameters of the experiment (e.g., which model parameter will be modified, the range of possible values to test, size of one or more test groups) may be specified previously by a user of test client 150.

An example experiment is testing one hundred different values in the range of 0.3 to 0.8 for 2% of user traffic. For the other 98% of user traffic, a model parameter value of 0.85 is used, indicating that an output of the model must be 0.85 or greater before a particular notification is sent to a particular user. Thus, one affect of the experiment may be to determine not only whether the number of user clicks of notifications increases as a result of the experiment, but also whether the number of disables of notifications increases as a result of the experiment.

At block 220, the result data is analyzed to generate metric data including multiple metrics. Block 220 may be performed by analyzer 140. The types of metrics depend on the type of result data that is analyzed. For example, if the result data indicates instances of users selecting a notification and instances of disables, then one metric may be a user selection (or click) rate of notifications and another metric may be a disable rate. Also, each metric is associated with a different tested model parameter value. Thus, analyzer 140 generates multiple metrics of the same type, but associated with different model parameter values or ranges of model parameter values.

At block 230, a metric of the multiple metrics is selected. Block 230 may involve randomly selecting a metric that has not yet been analyzed for variance. Blocks 230-280 may be implemented by metric selector 144.

At block 240, a maximum (or minimum) of the selected metric is determined for different values of the model parameter value. Block 240 may be characterized as optimizing the selected metric. For example, if the metric is one to maximize (e.g., CTR), then the metric data is analyzed to determine, for each model parameter value, a corresponding metric value for the selected metric. The metric values for the selected metric are analyzed to determine one or more maximum metric values. For example, if the metric is one to minimum (e.g., disables), then the metric data is analyzed to determine, for each model parameter value, a corresponding metric value for the selected metric. The metric values for the selected metric are analyzed to determine one or more minimum metric values.

At block 250, the model parameter value(s) that is/are associated with the maximum metric value(s) are identified. In other words, each model parameter value that results in a maximum metric value is tracked.

At block 260, a variance of the maximum metric value associated with each identified model parameter value is computed. Block 260 may involve computing multiple variances, one for each maximum metric value associated with an identified model parameter value. The variance of a maximum metric value may be computed using the following formula:

$$Var ( Y ( x ) ) = n ( x ) E ( σ ( f ( x ) ) ) ( 1 - E ( σ ( \text{?} ( x ) ) ) ) + V ( σ ( f ( x ) ) ) \text{?} {( x )}^{2} - n ( x ) )$$

$$\text{?} \text{indicates text missing or illegible when filed}$$

At block 270, a measure of the fluctuation of the selected metric is determined based on the computed variance(s). For example, if there are multiple computed variances, then the computed variances may be averaged. Alternatively, for each computed variance, a product of (1) the computed variance and (2) a probability associated with the computed variance (or a number of times that an identified model parameter associated with a maximum metric value occurred in a set) is computed and used as the fluctuation measure.

At block 280, it is determined whether there are any more metrics to select. For example, if block 230 has only been performed once while executing process 200, then there is at least one other metric to consider, since there are multiple metrics in a multi-objective optimization problem. Thus, if the determination in block 280 is affirmative, then process 200 returns to block 230. Otherwise, process 200 proceeds to block 290.

At block 290, the metric associated with the lowest fluctuation measure is selected as a primary objective in a multi-objective optimization problem.

In a related embodiment, a validation is performed to determine whether the distribution model selected (e.g., a Binomial distribution) was proper. The validation may involve implementing a resampling technique (e.g., Jackknife resampling) with respect to the underlying result data and performing a set of calculations. This validation step may occur before or after block 260. If the validation fails, then it is assumed that Y(x) follows another distribution model, such as a Poisson distribution or a Gaussian distribution and variance at the maximum/minimum is computed in a different way. For a Poisson distribution, a similar procedure as the Binomial distribution is followed. However, for a Gaussian distribution, Jackknife resampling is not used to compute a variance since variance is a free parameter.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

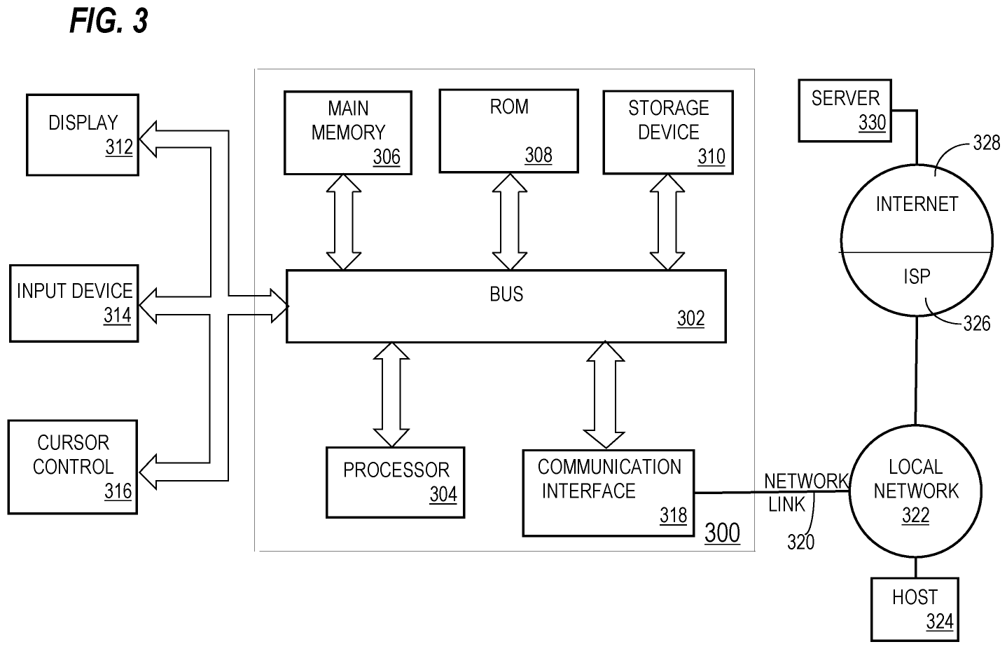

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing result data about a plurality of results of an experiment involving different values of a model parameter;
generating, based on the result data, a plurality of metrics;
for each metric of the plurality of metrics:
determining a maximum or minimum value of said each metric given a particular value of the model parameter;
determining, based on the maximum or minimum value, a variance associated with said each metric;
identifying a particular metric, of the plurality of metrics, that is associated with the lowest variance among the plurality of metrics;
using the particular metric as a primary metric in a multi-objective optimization problem involving the plurality of metrics.
wherein the method is performed by one or more computing devices.

2. The method of claim 1, further comprising:
for a first metric of the plurality of metrics:
determining a plurality of maximum or minimum values of the first metric given a plurality of values of the model parameter;
determining, based on the plurality of maximum or minimum values, a first variance associated with the first metric.

3. The method of claim 2, further comprising:
for each maximum or minimum value of the plurality of maximum or minimum values, determining a particular variance associated with said each maximum or minimum value;
wherein the first variance associated with the first metric is based on the particular variance associated with each maximum or minimum value of the plurality of maximum or minimum values.

4. The method of claim 2, further comprising:
for each maximum or minimum value of the plurality of maximum or minimum values, determining a probability of said each maximum or minimum value;
wherein determining the first variance is also based on the probability of each maximum or minimum value of the plurality of maximum or minimum values.

5. The method of claim 1, further comprising:
for a first metric of the plurality of metrics:
using a jackknife resampling technique to estimate a second variance given the particular value of the model parameter;
determining a difference between the second variance and the variance associated with the first metric;
based on the difference, determining whether to use a different distribution assumption in determining a variance of different values of the model parameter.

6. The method of claim 1, wherein determining the variance comprises determining the variance using one of a binomial distribution assumption, a Poisson distribution assumption, or a Gaussian distribution assumption.

7. The method of claim 1, wherein a first metric of the plurality of metrics is a number of connection invites sent and a second metric of the plurality of metrics is a number of connection invites accepted.

8. The method of claim 1, wherein a first metric of the plurality of metrics is a number of user selections and a second metric of the plurality of metrics is a number of disables.

9. The method of claim 1, wherein a first metric of the plurality of metrics is a number of viral actions and a second metric of the plurality of metrics is a number of engaged feed sessions.

10. One or more storage media storing instructions which, when executed by one or more processors, cause:
storing result data about a plurality of results of an experiment involving different values of a model parameter;
generating, based on the result data, a plurality of metrics;
for each metric of the plurality of metrics:
determining a maximum or minimum value of said each metric given a particular value of the model parameter;
determining, based on the maximum or minimum value, a variance associated with said each metric;
identifying a particular metric, of the plurality of metrics, that is associated with the lowest variance among the plurality of metrics;
using the particular metric as a primary metric in a multi-objective optimization problem involving the plurality of metrics.

11. The one or more storage media of claim 10, wherein the instructions, when executed by the one or more processors, further cause:
for a first metric of the plurality of metrics:
determining a plurality of maximum or minimum values of the first metric given a plurality of values of the model parameter;
determining, based on the plurality of maximum or minimum values, a first variance associated with the first metric.

12. The one or more storage media of claim 11, wherein the instructions, when executed by the one or more processors, further cause:
for each maximum or minimum value of the plurality of maximum or minimum values, determining a particular variance associated with said each maximum or minimum value;
wherein the first variance associated with the first metric is based on the particular variance associated with each maximum or minimum value of the plurality of maximum or minimum values.

13. The one or more storage media of claim 11, wherein the instructions, when executed by the one or more processors, further cause:
for each maximum or minimum value of the plurality of maximum or minimum values, determining a probability of said each maximum or minimum value;
wherein determining the first variance is also based on the probability of each maximum or minimum value of the plurality of maximum or minimum values.

14. The one or more storage media of claim 10, wherein the instructions, when executed by the one or more processors, further cause:
for a first metric of the plurality of metrics:
using a jackknife resampling technique to estimate a second variance given the particular value of the model parameter;
determining a difference between the second variance and the variance associated with the first metric;
based on the difference, determining whether to use a different distribution assumption in determining a variance of different values of the model parameter.

15. The one or more storage media of claim 10, wherein determining the variance comprises determining the variance using one of a binomial distribution assumption, a Poisson distribution assumption, or a Gaussian distribution assumption.

16. The one or more storage media of claim 10, wherein a first metric of the plurality of metrics is a number of connection invites sent and a second metric of the plurality of metrics is a number of connection invites accepted.

17. The one or more storage media of claim 10, wherein a first metric of the plurality of metrics is a number of user selections and a second metric of the plurality of metrics is a number of disables.

18. The one or more storage media of claim 10, wherein a first metric of the plurality of metrics is a number of viral actions and a second metric of the plurality of metrics is a number of engaged feed sessions.

19. A system comprising:
one or more processors;
one or more storage media storing instructions which, when executed by the one or more processors, cause:
storing result data about a plurality of results of an experiment involving different values of a model parameter;
generating, based on the result data, a plurality of metrics;
for each metric of the plurality of metrics:
determining a maximum or minimum value of said each metric given a particular value of the model parameter;
determining, based on the maximum or minimum value, a variance associated with said each metric;
identifying a particular metric, of the plurality of metrics, that is associated with the lowest variance among the plurality of metrics;
using the particular metric as a primary metric in a multi-objective optimization problem involving the plurality of metrics.

20. The system of claim 19, wherein the instructions, when executed by the one or more processors, further cause:
for a first metric of the plurality of metrics:
determining a plurality of maximum or minimum values of the first metric given a plurality of values of the model parameter;
determining, based on the plurality of maximum or minimum values, a first variance associated with the first metric.
